(19) United States
(12) Patent Application Publication
(10) Pub. No.: US 2005/0034272 A1
(43) Pub. Date: Feb. 17, 2005

(54) Hinge apparatus of drum for clothing dryer

(76) Inventors: In Cheol Jeong, Goyang (KR); Dae Yun Park, Gwangmyeong (KR); Young Hwan Park, Seoul (KR); Dong Beom Lee, Changwon (KR); Kyung Seop Hong, Incheon (KR); Si Moon Jeon, Seoul (KR)

Correspondence Address: BIRCH STEWART KOLASCH & BIRCH, PO BOX 747, FALLS CHURCH, VA, 22040-0747, US

(21) Appl. No.: 10/758,038

(22) Filed: Jan. 16, 2004

(30) Foreign Application Priority Data
Aug. 12, 2003 (KR) 10-2003-0055664

(51) Int. Cl. E05D 7/00

(52) U.S. Cl. 16/224

(57) ABSTRACT

A hinge apparatus of a drum for a clothing drier includes a front hinge portion formed between a front of a case and a front of a drum, for rotatably supporting the front of the drum; and a rear hinge portion installed between a rear of the case and a rear of the drum, and for supporting the rear of the drum so as to swing in vertical and horizontal directions, so that the drum can be smoothly rotated without being eccentric even in case that the center of rotation of the front of the drum is different from that of the rear of the drum, and also noise and vibration generated when the drum is rotated can be minimized.

### BACKGROUND OF THE INVENTION

1. Field of the Invention

The present invention relates to a clothing drier, and, more particularly, to a hinge apparatus of drum for a clothing drier capable of reducing vibration and noise generated when the drum rotates.

2. Description of the Background Art

In general, clothing driers are divided into a condensation type and a ventilation type or the like.

FIG. 1 is a block diagram of a condensation type-clothing drier according to the conventional art.

The conventional clothing drier includes a case 106 having an inlet 102 which is formed at a front surface of the case 106 and through which the clothes are put in and taken out, and a door 104 for opening/closing the inlet 102; a drum 110 rotatably supported at the inside of the case 106, and having an opening portion communicating with the inlet 102; a circulating duct 112 for supplying heated air into the inside of the drum 110, and through which the air that has dried clothes in the drum 110 is circulated; a circulating fan 116 installed at the circulating duct 112, and for forcibly circulating air through the circulating duct 112; a heater 118 installed at the circulating duct 112, and for heating air supplied to the drum 110; and a condenser 120 installed at one side of the circulating duct 112, and for eliminating moisture included in the air discharged from the drum 110.

The circulating duct 112 connects the front and the rear of the drum 110, supplies heated air to the rear of the drum 110, and discharges air, which has dried the clothed, to the front of the drum 110.

The front and the rear of the drum 110 are rotatably supported at the case 106 by a hinge apparatus respectively.

FIG. 2 is a sectional view showing a hinge apparatus of the drum of the clothing drier according to the conventional art.

The hinge apparatus of the drum according to the conventional art includes a sliding portion 130 formed at the front of the case 106, and for rotatably supporting an outer circumferential surface of the opening portion 108 of the drum; a hinge shaft 132 protruded from the center of the rear of the drum 110; and a bearing 134 by which the hinge shaft 132 is rotatably supported, and fixed at the case 106.

In the hinge apparatus of the drum according to the conventional art, the opening portion 108 formed at the front of the drum 110 is rotatably supported at the sliding portion 130, and the hinge shaft 132 connected to the rear of the drum 110 is rotatably supported at the case 106 by the bearing 134.

However, in the hinge apparatus of the drum for the clothing drier according to the conventional art constructed as above, as an assembly process or use hours are increased, the center of rotation of the drum and the center of the hinge shaft 132 supported by the bearing 134 may not be positioned collinearly. In such a case, eccentric abrasion occurs at the sliding portion 130 where the opening portion 108 of the drum slides, the drum cannot be rotated smoothly, and as the drum 110 is rotated with being eccentric, vibration and noise are generated.

### SUMMARY OF THE INVENTION

Therefore, an object of the present invention is to provide a hinge apparatus of a drum for a clothing drier capable of smoothly rotating a drum without being eccentric even in case that a center of rotation of the front of the drum is different from that of the rear of the drum, by having the center of rotary axis freely swing in vertical and horizontal directions.

To achieve these and other advantages and in accordance with the purpose of the present invention, as embodied and broadly described herein, there is provided a hinge apparatus of a drum for a clothing drier including a front hinge portion formed between a front of a case and a front of a drum, and for rotatably supporting the front of the drum; and a rear hinge portion installed between a rear of the case and a rear of the drum, and for supporting the rear of the drum so as to be swingable in vertical and horizontal directions.

The rear hinge portion includes a housing fixed at the center of the rear of the drum; a ball bearing inserted in the housing, and swinging in vertical and horizontal directions; and a shaft connected with the ball bearing, and fixed at the rear of the case.

The housing consists of a first housing and a second housing which are fixed at the rear of the case, and when the first and second housings are assembled, a spherical groove in which the ball bearing is swingably inserted, is formed.

At an outer surface of the case, a reinforcing member for reinforcing stiffness of the case when the shaft is engaged therewith is mounted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a block diagram of a clothing drier according to the conventional art;

FIG. 2 is a sectional view illustrating a hinge apparatus of a drum for a clothing drier according to the conventional art;

FIG. 3 is a block diagram of a clothing drier according to the present invention;

FIG. 4 is a perspective view of a disassembled hinge apparatus of a drum for a clothing drier according to the present invention;

FIG. 5 is a perspective view of a coupled hinge apparatus of a drum for a clothing drier according to the present invention;

FIG. 6 is a front view of a first housing of a hinge apparatus of a drum for a clothing drier according to the present invention;

FIG. 7 is a perspective view of a second housing of a hinge apparatus of a drum for the clothing drier according to the present invention; and

FIG. 8 is a partial perspective view showing one portion of a case with which a hinge apparatus of a drum according to the present invention is engaged.

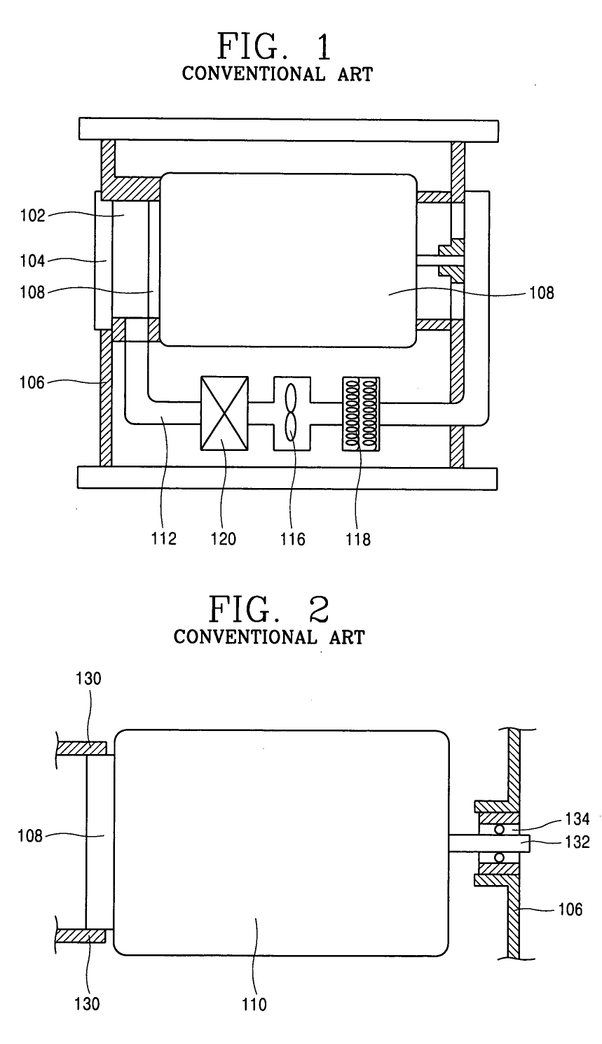

### DETAILED DESCRIPTION OF THE PREFERRED EMBODIMENTS

Reference will now be made in detail to the preferred embodiments of the present invention, examples of which are illustrated in the accompanying drawings.

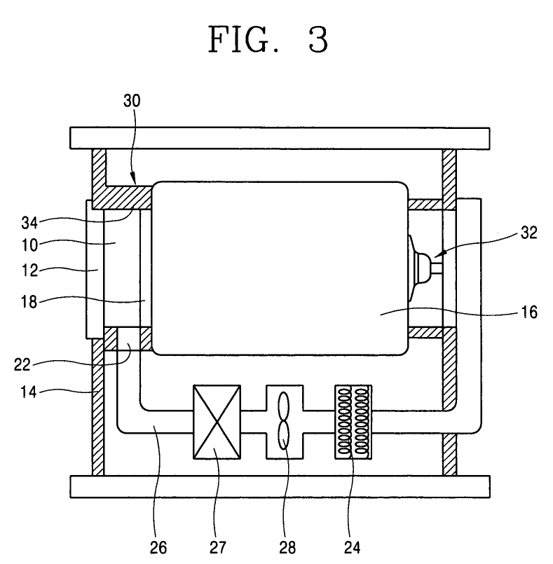

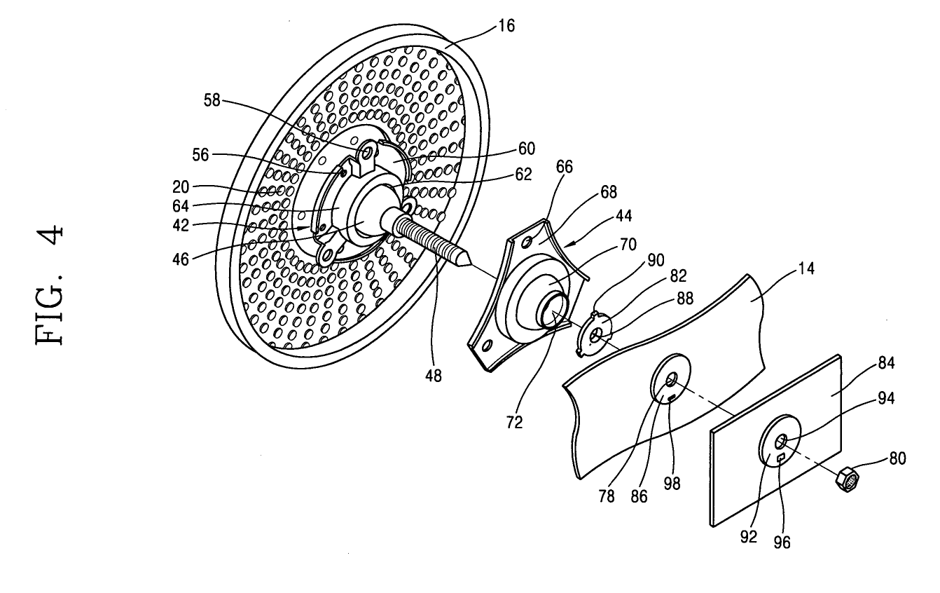

FIG. 3 is a block diagram of a clothing drier according to one embodiment of the present invention, and FIG. 4 is a sectional view of a hinge apparatus of a drum for a clothing drier according to the present invention.

The clothing drier according to the present invention includes a case 14 having an inlet 10 which is formed at the front of the case 14, and through which clothes are put in and taken out, and a door mounted at the inlet 10, for opening/closing the inlet 10; a drum 16 rotatably disposed at the inside of the case 14, and for drying clothes; a heated air supplying apparatus for supplying the heated air to the drum 16; and a hinge apparatus for rotatably supporting the drum 16.

An opening portion 18 is formed at the front of the drum 16, and communicates with the inlet 10 of the case 14. Thus through the opening portion 18, the clothes are put in to the drum 16. An air supplying hole 20 through which the air is supplied is formed at the rear of the drum 16. And an air discharging hole 22 is formed at the front of the drum 16, and through the air discharging hole 22, air, which has been supplied through the air supplying hole 20 and then has finished drying the clothes, is discharged.

As one embodiment of the heated-air supplying apparatus, a condensation type that re-heats the air which has finished a drying operation in the drum 16 and supplies the re-heated air to the drum 16, is used.

Such a heated air-supplying apparatus includes a circulating duct 26 connecting the air discharging hole 22 and the air supplying hole 20 which are formed at the front and the rear of the drum 16 respectively; a circulating fan 28 installed at the circulating duct 26, and for forcibly circulating air through the circulating duct 26; a condenser 27 for eliminating moisture included in the air discharged to the air discharging hole 22 and making the air dry; and a heater 24 for heating the air dried while passing through the condenser 27.

The hinge apparatus includes a front hinge portion 30 rotatably supporting the front of the drum 16; and a rear hinge portion 32 rotatably supporting the drum 16.

Herein, the front hinge portion 30 is composed of a cylindrical sliding supporting portion 34 formed at an inner surface of the front of the case 14 so as to rotatably support an outer circumferential surface of the opening portion 18 of the drum 16.

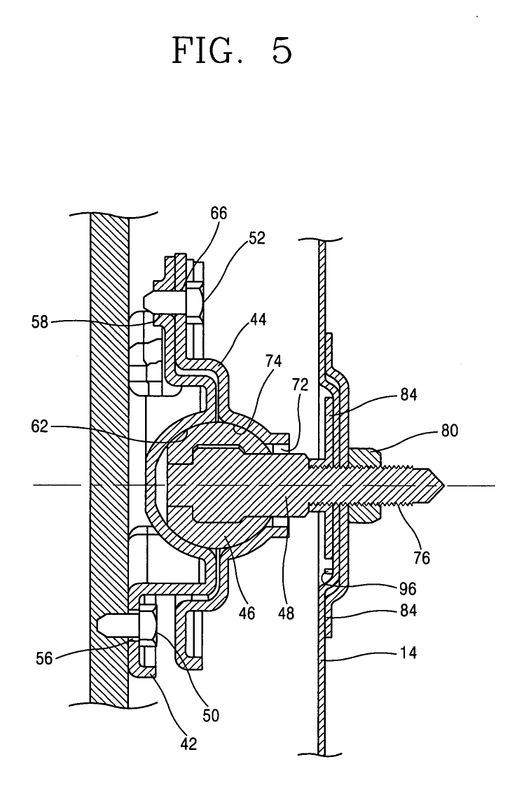

FIG. 4 is a perspective view of a disassembled rear hinge portion according to the present invention, and FIG. 5 is a sectional view of a coupled rear hinge portion according to the present invention.

As shown in FIG. 4, the rear hinge portion 32 includes a housing 42, 44 fixed at the center of the rear portion of the drum 16; a ball bearing 46 inserted in the housing 42, 44 so as to freely swing in vertical and horizontal directions; and a shaft 48 connected with the ball bearing 46, and fixed at the rear of the case 18.

The housing 42, 44 consists of a first housing 42 bolt 50—engaged with the rear surface of the case 16; and a second hosing 44 bolt 52—engaged with the first housing 42.

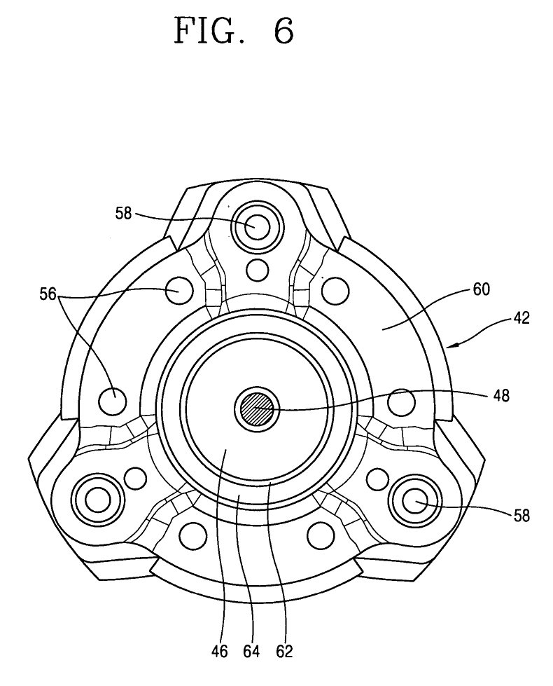

As shown in FIG. 6, the first housing 42 includes a first engaging portion 60 in which a plurality of bolt holes 56 for bolt 50—the case 14 and the first housing 42, and a plurality of bolt holes 58 for bolt 52—engaging the first housing 42 and the second housing 44, are formed in a circumferential direction; and a second hinge portion 64 formed at the center of the first engaging portion 60 and having a hemispherical shaped groove 62 in which the ball bearing 46 is inserted.

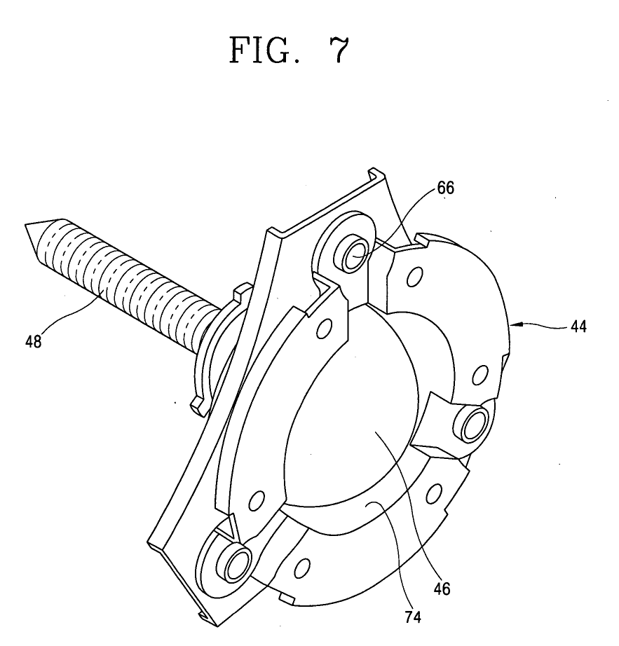

As shown in FIG. 7, the second housing 44 includes a second engaging portion 68 having a plurality of bolt holes 66 formed in a circumferential direction so as to be bolt 52—engaged with the first engaging portion 60 of the first housing 42; and a second hinge portion 70 formed at the center of the second engaging portion 68, and having a hemispherical groove 74 so as to become a spherical groove in which the ball bearing 46 is swingably inserted when the first hinge portion 64 and the second hinge portion 70 are assembled. And, at the second hinge portion 70, a penetrating hole 72 in which the shaft 48 is inserted is formed.

The ball bearing 46 is inserted in the spherical groove made of the two hemispherical grooves 62 and 74 when the first and second housings 42 and 44 are assembled, and freely swings in vertical and horizontal directions. And at the ball bearing 46, the shaft 48 is inserted and fixed.

At the surface of such a ball bearing 46, a groove (not shown) for a lubrication is formed, and the groove is filled with grease so that it lubricates when the ball bearing 46 is inserted in the spherical groove and swings.

One end of the shaft 48 is fixed at the ball bearing 46, and the other end thereof passes through a bolt engaging hole 78 formed at the case 14, is tightened at the rear surface of the case 14 by a nut 80, and thus is fixed at the case 14.

Herein, a base nut 82 is provided at an inner surface of the case 14 where the shaft 48 is fixed, and a reinforcing member 84 for reinforcing a state that the shaft 48 is fixed to the case 14 is provided at an outer surface of the case 14.

Herein, the base nut 82 is installed at a nut-installed portion 86 formed at the case 14, and makes an area where the case 14 and the nut 80 are in contact with each other bigger in case that the shaft 80 is tightened by the nut 80. The base nut 82 has a disc shape with a certain thickness, and a spiral hole 88 where the shaft 48 is spirally coupled is formed at the center of the base nut 82. And also, a plurality of stopping protrusions 90 is protruded at a certain interval therebetween in a circumferential direction of the base nut 82.

The reinforcing member 84 is fixed at the rear surface of the case 14 and is formed in a flat board shape having a certain thickness, a convex portion 92 having a convex shape is formed at the center of the reinforce member 84 so as to be attached to the rear surface of the nut-installed portion 86, and a penetrating hole 94 through which the shaft 48 passes is formed at the convex portion 92. And, a stopping pin 96 is protruded at the inner part of the convex portion 92, and is inserted into an insertion groove 98 formed at the nut-installed portion 86 of the case 14.

That is, such a reinforcing member 84 is fixed to the case 14 by a method of riveting, welding or the like, the stopping pin 96 is protruded at the inner part of the convex portion 86, and the insertion groove 98 into which the stopping pin 96 is inserted is formed at the nut-installed portion 86 of the case 14.

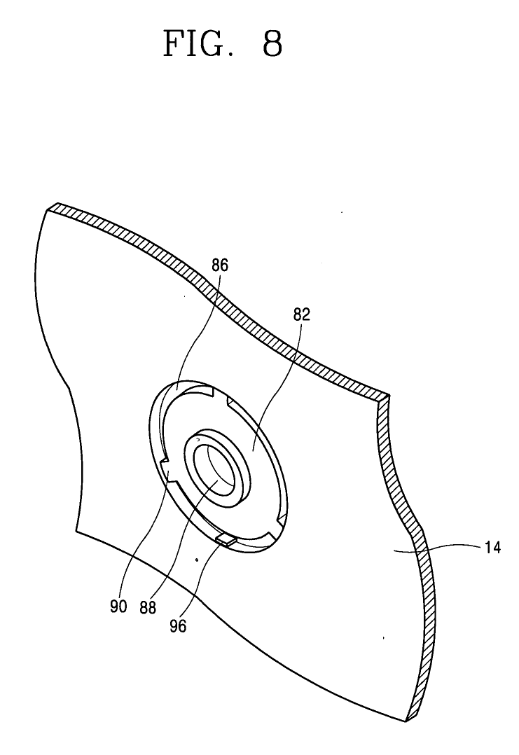

Herein, as shown in FIG. 8, the stopping pin 96 is protruded toward the inside of the nut-installed portion 86, thus stops a stopping protrusion 90 of the base nut 82 so that the base nut 82 is prevented from being rotated.

An assembly process and operations of the hinge apparatus of the drum according to the present invention constructed as above will now be described.

Firstly, in an assembly process of the hinge apparatus of the drum, the first housing 42 is bolt 50—engaged with the rear portion of the drum 16 through a bolt hole of the fist housing 42. And, the ball bearing 46 is positioned at the spherical groove 74 of the second housing 44, then, the shaft 48 connected with the ball bearing 46 is passed through the penetrating hole 72 formed at the second housing, and the second housing is bolt 52—engaged with the first housing 42. Then, the ball bearing 46 is swingably inserted at the first and second housings 42 and 44, and the first and second housings are fixed at the rear of the drum 16.

In this state, the base nut 82 is inserted into a spiral-formed portion 76, and then, the spiral-formed portion 76 is passed through the bolt engaging hole 78 formed at the case 14.

At this time, at the back surface of the case 14, a reinforcing member 84 is fixed by riveting, welding or the like. The stopping pin 96 of the reinforcing member 87 is passed through the insertion groove 98 formed at the case 14, and stops the stopping protrusion 90 of the base nut 82, so that the base nut is prevented from being rotated. And, assembling of the hinge apparatus is terminated by tightening the nut 80 to the spiral formed portion 76 of the shaft 48.

Herein, when the nut 80 is tightened, the base nut 82 is rotated with the shaft 48. At this time, the stopping pin stops the stopping protrusion of the base nut 84, so that the rotation of the base nut 84 is prevented thereby easily tightening the nut 80.

As operations of the hinge apparatus of the drum assembled as above, when the drum 16 is rotated to dry clothes, the front of the drum 16 is rotatably supported at a sliding supporting portion 34 formed at the front of the case 14, and the rear of the drum 16 is supported by the ball bearing 43 to be swingable in vertical and horizontal directions.

Accordingly, in the hinge apparatus of the drum according to the present invention constructed and operating as above, a housing is fixed at the rear of a drum, a ball bearing swinging in vertical and horizontal directions is inserted at the housing, and the ball bearing is fixed at the case by the shaft. Thus, even if a center of a rotary axis of the drum is changed, eccentricity of the drum does not occur and the drum can be smoothly rotated since the ball bearing can vary the rotary axis of the drum with swinging. And also, noise and vibration generated when the drum is rotated can be minimized.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A hinge apparatus of a drum for a clothing drier comprising:
a front hinge portion formed between a front of a case and a front of a drum, and for rotatably supporting the front of the drum; and
a rear hinge portion installed between a rear of the case and a rear of the drum, and for supporting so that the rear of the drum swings in vertical and horizontal directions.

2. The apparatus of claim 1, wherein the rear hinge portion comprises:
a housing fixed at the center of the rear of the drum;
a ball bearing inserted at the housing, and swinging in vertical and horizontal directions; and
a shaft connected with the ball bearing, and fixed at the rear of the case.

3. The apparatus of claim 2, wherein the housing consists of a first housing and a second housing which are fixed at the rear of the case, and when the first housing and the second housing are assembled, a spherical groove in which the ball bearing is swingably inserted is formed.

4. The apparatus of claim 3, the first housing comprises:
a first engaging portion having a bolt hole fixed at the rear surface of the case and a bolt engaging hole bolt-engaged with the second housing, said bolt hole and the bolt engaging hole being formed in a circumferential direction; and
a first hinge portion integrally formed at the center of the first engaging portion, and having a hemispherical groove in which the ball bearing is inserted.

5. The apparatus of claim 3, wherein the second housing comprises:
a second engaging portion having a plurality of bolt holes which is bolt-engaged with the first engaging portion; and
a second hinge portion having a hemispherical groove in which the ball bearing is inserted, and a penetrating hole through which the shaft passes.

6. The apparatus of claim 2, wherein one end of the shaft is fixed at the ball bearing, and the other end of the shaft has a spiral formed portion so as to be bolt-engaged with the case.

7. The apparatus of claim 6, wherein a base nut which is screw-engaged with the shaft is provided at an inner surface of the case.

8. The apparatus of claim 6, wherein the base nut has a disc shape installed at a nut-installed portion formed at the case, and a plurality of engaging protrusions is formed at a certain interval therebetween in a circumferential direction of the base nut.

9. The apparatus of claim 8, wherein a reinforcing member for reinforcing stiffness of the case when the shaft is engaged therewith is mounted at an outer surface of the case.

10 The apparatus of claim 9, wherein a stopping pin is formed at the reinforcing member, is inserted in the insertion groove formed at the case, and is protruded to the nut installed portion, so that the stopping pin stops the stopping protrusion.

11. The apparatus of claim 9, wherein the reinforcing member is fixed to the case by welding or riveting.
